(19) United States
(12) Patent Application Publication
(10) Pub. No.: US 2020/0330806 A1
(43) Pub. Date: Oct. 22, 2020

(54) FIRE EXTINGUISHER HOLDER

(71) Applicants: KOREA GYEONGGIDO. CO., LTD., Seongnam-si (KR); GyeongGi-Do, Suwon-si (KR)

(72) Inventor: Yong Woo CHOI, Seoul (KR)

(21) Appl. No.: 16/512,976

(22) Filed: Jul. 16, 2019

(30) Foreign Application Priority Data
Apr. 16, 2019 (KR) 10-2019-0044196

(51) Int. Cl. A62C 13/78

(52) U.S. Cl. CPC A62C 13/78

(57) ABSTRACT

Provided is a fire extinguisher holder, including: a bracket that includes multiple fixing holes to fix the bracket to a ceiling using fixing means and has a U-shape with one side open; a column part whose upper ends are fixed to the bracket; and a support part that is located at a lower portion of the column part and configured to support a lower surface of the fire extinguisher, and a cap part of the fire extinguisher is sliding-coupled to the bracket to fix the fire extinguisher.

### TECHNICAL FIELD

The present disclosure relates to a fire extinguisher holder.

### BACKGROUND

Typically, a fire extinguisher includes a vessel containing a fire extinguishing agent and a propellant, such as compressed air or non-combustible gas (nitrogen, CO₂, etc.), which is used to expel the fire extinguishing agent. Fire extinguishers can be classified into stored-pressure fire extinguishers, pressurized fire extinguishers (manual pump fire extinguishers, chemical reaction type fire extinguishers, gas pressurized fire extinguishers), CO₂ fire extinguishers, and halon fire extinguishers depending on their propellants and spraying methods or characteristics of fire extinguishing targets and thus have been used in somewhat different ways from each other.

Further, according to the fire protection laws for buildings, general offices, market buildings, apartments, houses, and the like are required to be provided with a fire extinguisher to quickly use the fire extinguisher in case of fire.

Also, public facilities such as subways, gymnasiums, and the like are required to be provided with a fire extinguisher to prepare for emergency situations, and people residing in a building regularly practice fire drills.

### SUMMARY

In view of the foregoing, the present disclosure provides a fire extinguisher holder configured to safely protect and keep a fire extinguisher.

However, problems to be solved by the present disclosure are not limited to the above-described problems. There may be other problems to be solved by the present disclosure.

According to an aspect of the present disclosure, a fire extinguisher holder includes: a bracket that includes multiple fixing holes to fix the bracket to a ceiling using fixing means and has a U-shape with one side open; a column part whose upper ends are fixed to the bracket; and a support part that is located at a lower portion of the column part and configured to support a lower surface of the fire extinguisher, and a cap part of the fire extinguisher is sliding-coupled to the bracket to fix the fire extinguisher.

According to the present disclosure, a fire extinguisher can be fixed to a ceiling. Therefore, it is possible to safely protect and keep the fire extinguisher with high space efficiency and also possible to make it much easier to recognize the location of the fire extinguisher.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a perspective view of a fire extinguisher holder in accordance with various embodiments described herein.

FIG. 2 is a diagram illustrating a fire extinguisher loaded in the fire extinguisher holder in accordance with various embodiments described herein.

FIG. 3 is an exploded perspective view of the fire extinguisher holder in accordance with various embodiments described herein.

FIG. 4 is a perspective view of a cap part of the fire extinguisher in accordance with various embodiments described herein.

FIG. 5 is an enlarged view of “A” in FIG. 3 in accordance with various embodiments described herein.

FIG. 6 is a diagram provided to explain a method of loading the fire extinguisher in the fire extinguisher holder in accordance with various embodiments described herein.

### EXPLANATION OF REFERENCE NUMERALS

100: Fire extinguisher holder

110: Bracket

111: Step portion

112: Protrusion portion

113: Frame insertion groove

114: Settling groove

115: Recess portion

120: Column part

121: Column frame

122: Fixed frame

123: Fixing part

130: Support part

200: Fire extinguisher

210: Cap part

211: Cap housing

212: Loading portion

220: Main body

30: Fixing means

### DETAILED DESCRIPTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

The present disclosure relates to a fire extinguisher holder. For example, a fire extinguisher loaded in the fire extinguisher holder may be a spray type fire extinguisher, but may not be limited thereto.

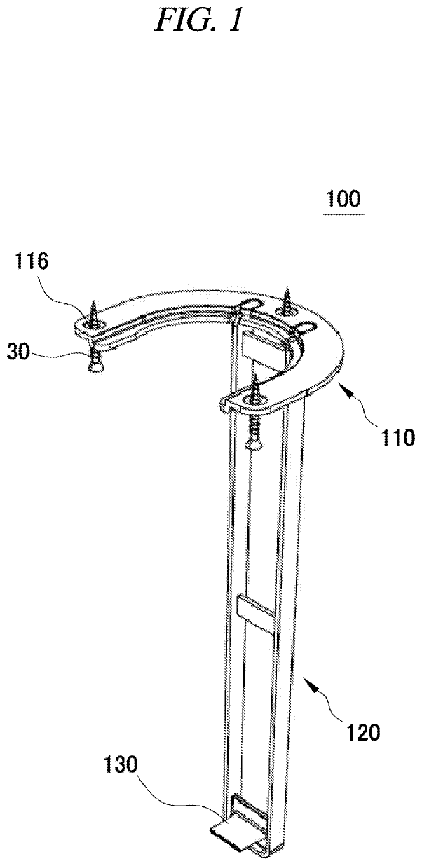

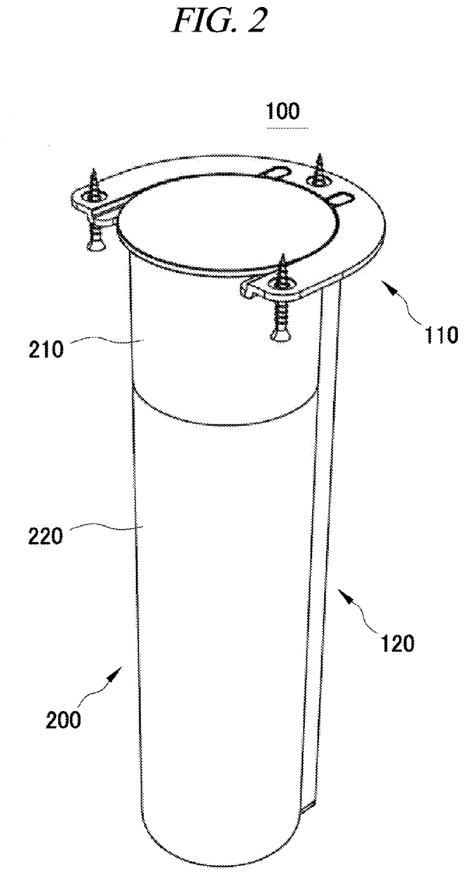

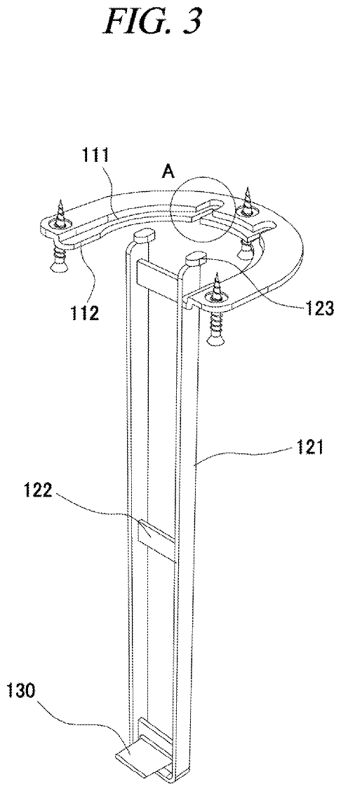

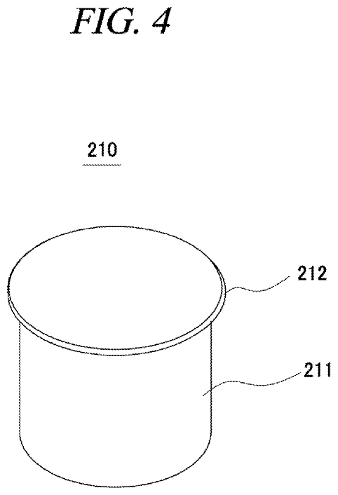

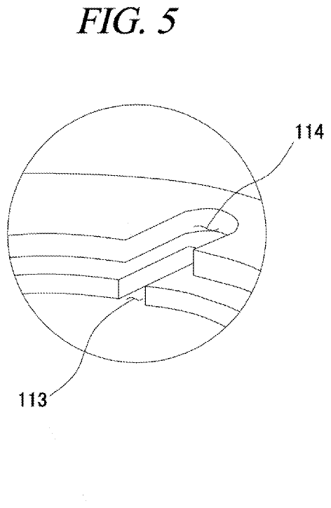

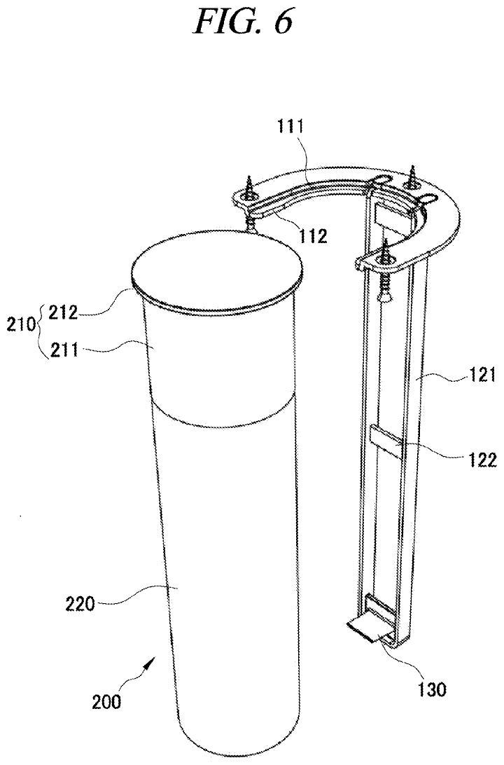

FIG. 1 is a perspective view of a fire extinguisher holder in accordance with various embodiments described herein, FIG. 2 is a diagram illustrating a fire extinguisher loaded in the fire extinguisher holder in accordance with various embodiments described herein, FIG. 3 is an exploded perspective view of the fire extinguisher holder in accordance with various embodiments described herein, FIG. 4 is a perspective view of a cap part of the fire extinguisher in accordance with various embodiments described herein, FIG. 5 is an enlarged view of “A” in FIG. 3 in accordance with various embodiments described herein, and FIG. 6 is a diagram provided to explain a method of loading the fire extinguisher in the fire extinguisher holder in accordance with various embodiments described herein.

Hereafter, a fire extinguisher holder 100 in accordance with various embodiments described herein (hereafter, referred to as “fire extinguisher holder 100”) will be described with reference to FIG. 1 and FIG. 2.

The fire extinguisher holder 100 may include a bracket 110, a column part 120, and a support part 130.

The bracket 110 may include multiple fixing holes 116 to fix the bracket 110 to a ceiling using fixing means 30 and have a U-shape with one side open. In other words, the bracket 110 may be fixed to the ceiling by allowing the fixing means 30 to pass through the multiple fixing holes 116 from bottom to top. Further, a cap part 210 of a fire extinguisher 200 may be sliding-coupled to the bracket 110 through an opening part to fix the fire extinguisher 200. Details thereof will be described later.

Accordingly, the fire extinguisher holder 100 can fix the fire extinguisher 200 to the ceiling. Therefore, it is possible to increase space efficiency and also possible to make it easy for a user to recognize the location of the fire extinguisher 200.

An upper end of the column part 120 is fixed to the bracket 110. In other words, the upper end of the column part 120 is coupled to the bracket 110 and the support part 130 to be described later is located at a lower end of the column part 120, and, thus, the column part 120 may fix the support part 130.

The support part 130 may be located at a lower portion of the column part 120 and configured to support a lower surface of the fire extinguisher 200. In other words, referring to FIG. 2, when the fire extinguisher 200 is loaded in the fire extinguisher holder 100, the cap part 210 of the fire extinguisher 200 may be coupled to the bracket 110 and a lower portion of a main body 220 of the fire extinguisher 200 may be settled on an upper surface of the support part 130 to securely fix the fire extinguisher 200.

Hereafter, the fire extinguisher holder 100 in accordance with various embodiments described herein will be described in detail with reference to FIG. 3 through FIG. 6.

The bracket 110 in accordance with various embodiments described herein will be described first.

As described above, the bracket 110 may have a U shape with one side open and may be fixed to the ceiling through the fixing means 30 such as screws. Herein, referring to FIG. 4, the cap part 210 of the fire extinguisher 200 may include a cylindrical cap housing 211 and a loading portion 212 protruded along an upper periphery of the cap housing 211. Further, the main body 220 of the fire extinguisher 200 may be inserted and fixed in a lower portion of the cap part 210 of the fire extinguisher 200.

Further, the bracket 110 may include a step portion 111 that has a stepped upper surface along an inner periphery in order to allow the cap part 210 of the fire extinguisher 200 to insert therein. Specifically, referring to FIG. 6, if the bracket 110 is installed at the ceiling, an upper surface of the bracket 110 is closely attached to the ceiling and the loading portion 212 of the cap part 210 is sliding-coupled to a space between the ceiling and the upper surface of the step portion 111, and, thus, the cap part 210 can be fixed without separation in a downward direction.

Further, the step portion 111 may include a protrusion portion 112 symmetrically protruded at an opening part of the inner periphery in an inward direction. Furthermore, the inner periphery of the step portion 111 may be formed to correspond to the cap housing 211.

Specifically, when the cap part 210 is inserted into the step portion 111, it is coupled by stationary fit by the protrusion portion 112. Thus, it is possible to suppress separation of the cap part 210 from the bracket 110 caused by a vibration or slight shock. Further, the inner periphery of the step portion 111 is concentric with the cap housing 211, and, thus, the cap part 210 is not deformed and can be stably fixed.

Hereafter, the column part 120 in accordance with various embodiments described herein will be described in detail with reference to FIG. 2.

The column part 120 may include a column frame 121, a fixed frame 122, and a fixing part 123.

The column frame 121 may include an upper end fixed to the bracket 110 and have a U-shape. For example, the column frame 121 may be manufactured by bending a long plate into a U-shape with both ends facing upward, but may not be limited thereto. The column frame 121 may be manufactured by arranging I-shaped plate members apart from each other at a predetermined distance.

Both ends of the fixed frame 122 are fixed to the column frame 121, and there may be multiple fixed frames 122 apart from each other at a predetermined distance along a longitudinal direction of the column frame 121. Since the both ends of the fixed frame 122 are fixed to the column frame 121, it is possible to suppress deformation of the column frame 121.

The fixing part 123 may be located at an upper end of the column frame 121 and fixed to the bracket 110 and may have an elliptical shape. Specifically, referring to FIG. 5, the bracket 110 includes a frame insertion groove 113 in which an upper portion of the column frame 121 is sliding-inserted and a settling groove 114 which is located above the frame insertion groove 113 and in which the fixing part 123 is inserted and fixed.

That is, when the column frame 121 is coupled to the bracket 110, the column frame 121 may be inserted into the frame insertion groove 113 and then the fixing part 123 is settled on the settling groove 113. Thus, the column part 120 can be fixed to the bracket 110. Herein, the settling groove 114 may be formed greater than the frame insertion groove 113, and as the fixing part 123 is settled on the settling groove 114, its downward movement may be restricted.

The bracket 110 may further include recess portions (not illustrated) which are located on a lower surface of the bracket 110 and concentric with the fixing holes and recessed in an upward direction. In other words, when the bracket 110 is fixed using the fixing means 30, the fixing means 30 pass through the fixing holes 116 from bottom to top to fix the bracket 110. Herein, the heads of the fixing means 30 are located in the recess portions, respectively, in order to suppress the protrusion of the heads of the fixing means 30 to the outside. Therefore, it is possible to avoid damage to the user by the fixing means 30.

As described above, the support part 130 may be located at the lower portion of the column part 120 and configured to support the lower surface of the fire extinguisher 200. For example, the support part 130 may be coupled to the fixed frame 122 as shown in FIG. 2, but may not be limited thereto. The support part 130 may be coupled to a lower portion of the column frame 121.

Further, the support part 130 may be protruded from the column part 120 with a length shorter than the diameter of the main body 220 of the fire extinguisher 200. Therefore, when the user pulls the fire extinguisher 200 toward his/her lower body, he/she can easily separate the fire extinguisher 200 from the fire extinguisher holder 100.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A fire extinguisher holder, comprising:
a bracket that includes multiple fixing holes to fix the bracket to a ceiling using fixing means and has a U-shape with one side open;
a column part whose upper ends are fixed to the bracket; and
a support part that is located at a lower portion of the column part and configured to support a lower surface of the fire extinguisher,
wherein a cap part of the fire extinguisher is sliding-coupled to the bracket to fix the fire extinguisher.

2. The fire extinguisher holder of claim 1,
wherein the cap part of the fire extinguisher includes:
a cylindrical cap housing; and
a loading portion protruded along an upper periphery of the cap housing.

3. The fire extinguisher holder of claim 2,
wherein the bracket includes:
a step portion that has a stepped upper surface along an inner periphery in order to allow the loading portion of the cap part to insert therein.

4. The fire extinguisher holder of claim 3,
wherein the step portion includes:
a protrusion portion that is symmetrically protruded at an opening part of the inner periphery in an inward direction.

5. The fire extinguisher holder of claim 4,
wherein the inner periphery of the step portion is formed to correspond to the cap housing.

6. The fire extinguisher holder of claim 1,
wherein the column part includes:
a column frame that has a U-shape and includes an upper end fixed to the bracket;
a fixed frame whose both ends are fixed to the column frame and which includes multiple fixed frames apart from each other at a predetermined distance along a longitudinal direction of the column frame; and
an elliptical fixing part that is located at an upper end of the column frame and fixed to the bracket.

7. The fire extinguisher holder of claim 6,
wherein the bracket includes:
a frame insertion groove in which an upper portion of the column frame is sliding-inserted; and
a settling groove which is located above the frame insertion groove and in which the fixing part is inserted and fixed.

8. The fire extinguisher holder of claim 1,
wherein the bracket further includes:
recess portions which are located on a lower surface of the bracket and concentric with the fixing holes and recessed in an upward direction.

9. The fire extinguisher holder of claim 1,
wherein the support part is protruded from the column part with a length shorter than the diameter of a main body of the fire extinguisher.

10. The fire extinguisher holder of claim 1,
wherein the fire extinguisher is a spray type fire extinguisher.
